(19) United States
(12) Patent Application Publication
(10) Pub. No.: US 2015/0006292 A1
(43) Pub. Date: Jan. 1, 2015

(54) PROMOTION SCHEDULING MANAGEMENT

(71) Applicants: Wen-Syan Li, Fremont, CA (US); Xingtian Shi, Shanghai (CN)

(72) Inventors: Wen-Syan Li, Fremont, CA (US); Xingtian Shi, Shanghai (CN)

(73) Assignee: SAP AG, Walldorf (DE)

(21) Appl. No.: 13/934,803

(22) Filed: Jul. 3, 2013

(30) Foreign Application Priority Data
Jun. 28, 2013 (CN) 201310269282.0

(51) Int. Cl. G06Q 30/02

(52) U.S. Cl. CPC G06Q 30/0264
USPC 705/14.61

(57) ABSTRACT

In accordance with aspects of the disclosure, systems and methods are provided for managing promotion scheduling by generating a promotion sales plan for scheduling promotion events within one or more time intervals based on potential promotion sales strategies for use with one or more products within the one or more time intervals while considering constraints related to the historic sales data for each product.

### CROSS-REFERENCE TO RELATED APPLICATION

This application claims priority under 35 U.S.C. §119 to Chinese Patent Application No. 201310269282.0, filed on Jun. 28, 2013, entitled “PROMOTION SCHEDULING MANAGEMENT”, which is incorporated herein by reference in its entirety.

### TECHNICAL FIELD

The present description relates to various computer-based techniques for promotion scheduling management.

### BACKGROUND

In typical retail environments, sales plans may be considered an important issue when trying to meet customer demand and analyze profitability. Sales plans may be used by retailers to meet objectives, such as inventory clearing, revenue goals, and profit enabling. In a scenario, a decision maker may set a sales plan based on knowledge and experience. Quantitative analysis may be used with external experts, and a proposal may be on a strategic level and may not be employed on a daily operational basis. Since some parameters and variables may be introduced in a sales plan, using decision-making and calculations to develop an efficient solution may be considered difficult. As such, there exists a need to optimize sales planning where efficient solutions are determined.

### SUMMARY

In accordance with aspects of the disclosure, a computer system may be provided for promotion scheduling management including instructions recorded on a computer-readable medium and executable by at least one processor. The computer system may include a promotion scheduling manager configured to cause the at least one processor to schedule one or more promotion events for each of one or more products relative to one or more time intervals while considering one or more constraints related to historic sales data for each of the one or more products. The promotion scheduling manager may include a promotion forecaster configured to determine the one or more constraints based on the historic sales data for each of the one or more products and a promotion coordinator configured to determine one or more potential promotion sales strategies for use with each of the one or more products within the one or more time intervals while considering the one or more constraints related to the historic sales data for each of the one or more products. The promotion scheduling manager may include a promotion scheduling optimizer configured to generate a promotion sales plan for scheduling the one or more promotion events within the one or more time intervals based on the one or more potential promotion sales strategies for use with each of the one or more products within the one or more time intervals while considering the one or more constraints related to the historic sales data for each of the one or more products.

In various implementations, the promotion scheduling manager may be configured to schedule the one or more promotion events for each of the one or more products based on forecasted customer demand relative to the one or more time intervals while considering the one or more constraints related to the historic sales data for each of the one or more products. The promotion scheduling manager may be configured to schedule the one or more promotion events for each of the one or more products based on long-term effects to sales performance relative to the one or more time intervals while considering the one or more constraints related to the historic sales data for each of the one or more products. The promotion scheduling manager may be configured to schedule the one or more promotion events for each of the one or more products relative to the one or more time intervals while considering forecasted customer demand related to the historic sales data for each of the one or more products. The promotion scheduling manager may be configured to schedule the one or more promotion events for each of the one or more products relative to the one or more time intervals while considering long-term effects to sales performance related to the historic sales data for each of the one or more products.

In an implementation, the promotion coordinator may be configured to determine the one or more potential promotion sales strategies for use with a combination of two or more products within the one or more time intervals while considering the one or more constraints related to the historic sales data for each of the one or more products.

In an implementation, the promotion scheduling optimizer may be configured to generate the promotion sales plan for scheduling the one or more promotion events within the one or more time intervals based on handling different forecast scenarios while considering the one or more constraints related to the historic sales data for each of the one or more products, the different forecast scenarios including one or more of adjusting to real-time scenarios and long-term scenarios related to one or more of different customer demand scenarios, different product inventory scenarios, and different sales performance scenarios. The promotion scheduling optimizer may be configured to generate the promotion sales plan for scheduling the one or more promotion events within the one or more time intervals based on real-time sales data for each of the one or more products within the one or more time intervals while considering the one or more constraints related to the historic sales data for each of the one or more products.

In an implementation, the one or more constraints may include restricted use of a specified number of the potential promotion sales strategies determined for use with each of the one or more products within the one or more time intervals. The one or more constraints may include a specified number of instances that the potential promotion sales strategies are used for each of the one or more products within the one or more time intervals. The one or more constraints may include a specified revenue goal or a value greater than the specified revenue goal for scheduling the one or more promotion events within the one or more time intervals based on the one or more potential promotion sales strategies.

In an implementation, the system may include a promotion sales monitor that may be configured to monitor real-time sales data for each of the one or more products. The system may include one or more databases configured to store the historic sales data for each of the one or more products. The historic sales data may include one or more of customer product demand, product sales history, current product inventory, and an amount of incoming products.

In accordance with aspects of the disclosure, a computer-implemented method may be provided for promotion scheduling management. In an implementation, the computer-implemented method may include determining one or more constraints based on historic sales data for each of one or more products and determining one or more potential promotion sales strategies for use with each of the one or more products within one or more time intervals while considering the one or more constraints related to the historic sales data for each of the one or more products. The computer-implemented method may include generating a promotion sales plan for scheduling one or more promotion events within the one or more time intervals based on the one or more potential promotion sales strategies for use with each of the one or more products within the one or more time intervals while considering the one or more constraints related to the historic sales data for each of the one or more products.

In an implementation, generating the promotion sales plan for scheduling the one or more promotion events within the one or more time intervals is based on handling different forecast scenarios while considering the one or more constraints related to the historic sales data for each of the one or more products, the different forecast scenarios including one or more of adjusting to real-time scenarios and long-term scenarios related to one or more of different customer demand scenarios, different product inventory scenarios, and different sales performance scenarios.

In an implementation, the one or more constraints include one or more of restricted use of a specified number of the potential promotion sales strategies determined for use with each of the one or more products within the one or more time intervals, a specified number of instances that the potential promotion sales strategies are used for each of the one or more products within the one or more time intervals, and a specified revenue goal or a value greater than the specified revenue goal for scheduling the one or more promotion events within the one or more time intervals based on the one or more potential promotion sales strategies.

In an implementation, monitoring real-time sales data for each of the one or more products, and generating the promotion sales plan for scheduling the one or more promotion events within the one or more time intervals is based on the real-time sales data for each of the one or more products within the one or more time intervals while considering the one or more constraints related to the historic sales data for each of the one or more products.

In an implementation, the computer-implemented method may include storing the historic sales data for each of the one or more products in one or more databases, the historic sales data including one or more of customer product demand, product sales history, current product inventory, and an amount of incoming products.

In accordance with aspects of the disclosure, a computer program product may be provided, wherein the computer program product is tangibly embodied on a computer-readable storage medium and includes instructions that, when executed by at least one processor, may be configured to determine one or more constraints based on historic sales data for each of one or more products and determine one or more potential promotion sales strategies for use with each of the one or more products within one or more time intervals while considering the one or more constraints related to the historic sales data for each of the one or more products. The instructions, when executed by the at least one processor, may be further configured to generate a promotion sales plan for scheduling one or more promotion events within the one or more time intervals based on the one or more potential promotion sales strategies for use with each of the one or more products within the one or more time intervals while considering the one or more constraints related to the historic sales data for each of the one or more products.

In an implementation, the instructions that, when executed by the at least one processor, may be configured to generate the promotion sales plan for scheduling the one or more promotion events within the one or more time intervals may be based on handling different forecast scenarios while considering the one or more constraints related to the historic sales data for each of the one or more products. The different forecast scenarios may include one or more of adjusting to real-time scenarios and long-term scenarios related to one or more of different customer demand scenarios, different product inventory scenarios, and different sales performance scenarios.

In various implementations, the one or more constraints may include one or more of restricted use of a specified number of the potential promotion sales strategies determined for use with each of the one or more products within the one or more time intervals, a specified number of instances that the potential promotion sales strategies are used for each of the one or more products within the one or more time intervals, and a specified revenue goal or a value greater than the specified revenue goal for scheduling the one or more promotion events within the one or more time intervals based on the one or more potential promotion sales strategies.

In an implementation, the instructions that, when executed by the at least one processor, may be configured to monitor real-time sales data for each of the one or more products, and further, the instructions that, when executed by the at least one processor, may be configured to generate the promotion sales plan for scheduling the one or more promotion events within the one or more time intervals may be based on the real-time sales data for each of the one or more products within the one or more time intervals while considering the one or more constraints related to the historic sales data for each of the one or more products.

In an implementation, the instructions that, when executed by the at least one processor, may be configured to store the historic sales data for each of the one or more products in one or more databases, the historic sales data including one or more of customer product demand, product sales history, current product inventory, and an amount of incoming products.

The details of one or more implementations are set forth in the accompa-nying drawings and the description below. Other features will be apparent from the description and drawings, and from the claims.

### BRIEF DESCRIPTION OF THE DRAWINGS

FIG. 1 is a block diagram illustrating an example system for promotion scheduling management, in accordance with aspects of the disclosure.

FIG. 2 is a process flow illustrating an example method for managing promotion scheduling, in accordance with aspects of the disclosure.

FIG. 3 is a diagram illustrating an example graph showing customer demand, in accordance with aspects of the disclosure.

FIG. 4 is a diagram illustrating an example graph showing time for achieving optimal solutions with different numbers of products in an optimization, in accordance with aspects of the disclosure.

FIG. 5 is a diagram illustrating an example graph showing how the parameters may affect performance, in accordance with aspects of the disclosure.

FIG. 6 is a diagram illustrating example graphs showing a known sales curve and a forecast sales curve, in accordance with aspects of the disclosure.

### DETAILED DESCRIPTION

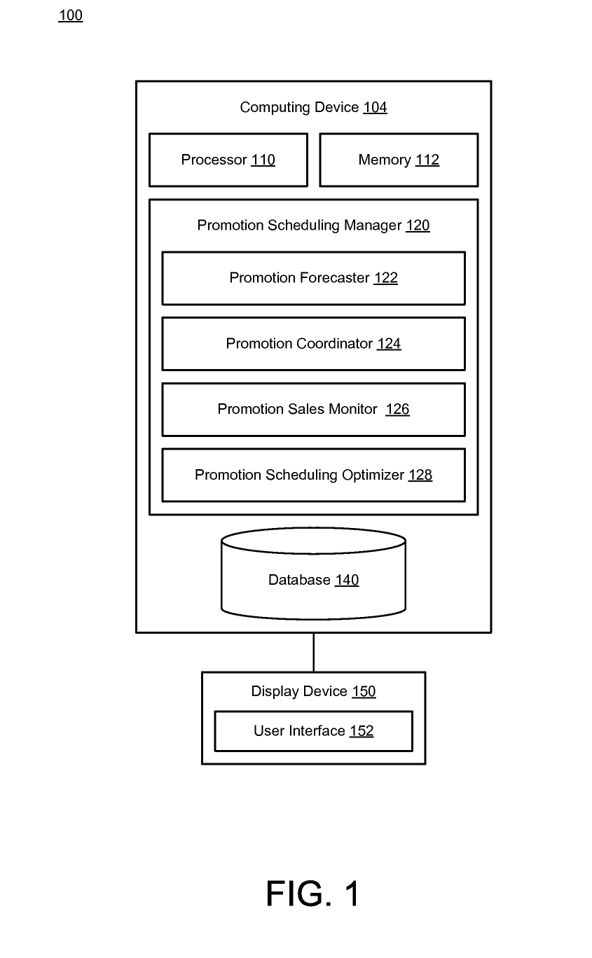

FIG. 1 is a block diagram illustrating an example system 100 for promotion scheduling management, in accordance with aspects of the disclosure.

In the example of FIG. 1, the system 100 comprises a computer system for implementing a promotion scheduling management system that may be associated with a computing device 104, thereby transforming the computing device 104 into a special purpose machine designed to implement promotion scheduling process(es), as described herein. In this instance, the computing device 104 may include any standard element(s) and/or component(s), including at least one processor(s) 110, memory 112 (e.g., non-transitory computer-readable storage medium), database(s) 140, power, peripherals, and various other computing elements and/or components that may not be specifically shown in FIG. 1. Further, the system 100 may be associated with a display device 150 (e.g., a monitor or other display) that may be used to provide a user interface (UI) 152, such as, in some examples, a graphical user interface (GUI). In some examples, the UI 152 may be used to receive preferences from a user for managing or utilizing the system 100. As such, various other element(s) and/or component(s) of the system 100 that may be useful for purpose of implementing the system 100 may be added or included, as would be apparent to one of ordinary skill in the art.

In the example of FIG. 1, the promotion scheduling management system 100 may include the computing device 104 and instructions recorded on the non-transitory computer-readable medium 112 and executable by the at least one processor 110. Further, the promotion scheduling management system 100 may include the display device 150 for providing output to a user, and the display device 150 may include the UI 152 for receiving input from the user.

In an implementation, the example system 100 for promotion scheduling management may include a system and related methods for optimizing a promotion plan including a promotion sales plan with consideration of or while considering demand forecast, long-term effects, and/or multiple constraints. For instance, various promotion sales plans may be used by retailers to meet their different objectives, such as inventory clearing and revenue or profit enabling. In a retailer scenario, a decision maker may set a promotion sales plan based on personal domain knowledge and experience. Further, in some examples, with advancement of information technology (IT), storing historic sales data and monitoring real-time data flow, such as, e.g., user demand, sales history, current inventory, and/or an amount of incoming products, may be simplified. Still further, in some other examples, dynamic optimization of promotion sales plans may be simplified with the example system 100 configured to react in real-time and be able to handle different scenarios with short-term effects and/or long-term effects.

In an example, long-term effects may include situations where customers are used to seeing a product sold at a discounted price, which may result in the customers not choosing to purchase the product at a regular price. In another example, long-term effects may include situations where product sales increase during a promotion, but then the product sales decrease in the weeks after a sales promotion ends. Hence, promotion sales plans may need to consider one or more various constraints to meet logical business practices, such as, for example, only a small portion of products may discounted at one time, and in another example, a small number of products may be combined together to be promoted together, but in some examples, not too many of products are combined.

Thus, in accordance with aspects of the disclosure, the example system 100 and various methods related thereto may be configured to optimize a promotion sales plan while considering demand forecast (e.g., including customer demand forecast), short-term effects, long-term effects, and one or more constraints. For instance, the example system 100 and various methods related thereto may be configured to estimate and/or forecast values of factors that may be critical for decision making based on historic data, including historic sales data. External factors, such as trend, seasonality, and/or anomaly events may be considered. The example system 100 and various methods related thereto may be configured to vary promotion sales plans depending on effects and various other factors including bundling, coupons, price discount, buying a larger quantity for a lower price, buying x and getting y free, which are possible methods for a decision maker to choose and consider for possible solutions. In proposed models, one or more of these promotion sales methods may be integrated into the optimization.

Further, in accordance with aspects of the disclosure, the example system 100 and various methods related thereto may be configured to use various constraints for planning in real-life. These constraints may be considered useful for finding a feasible promotion sales plan and may be considered in the model. The example system 100 and various methods related thereto may be configured to consider sales promotion as a short-term behavior, and the decision maker may focus on short-term goals, such as revenue during the promotion. However, the example system 100 and various methods related thereto may be configured to consider product sales after promotion from a long-term perspective. In an example, stickiness may be defined as demand elasticity of a customer as the product price changes. For those products of which the stickiness is low, a large discount may harm sales performance in near future when a price for a product returns to normal. Therefore, the example system 100 and various methods related thereto may be configured to combine long-term effects with objective function. For instance, after one or more reasonable estimates regarding one or more or all factors are taken into account, an objective function may be created of which input variables may include potential sales strategies with one or more predefined constraints. Further, some techniques such as linear optimization and quadratic computing may be used to give some final results. In other examples, a proposed promotion sales plan solution may consider one or more or several products at one time (e.g., a combination of products), which may tend to ignore a relation between some or all selling products on an overall level. This may be considered for promotion sales plan that seeks a global optimum on different objectives, such as, for example, revenue, profit, and/or customer satisfaction. As such, in some instances, the example system 100 and various methods related thereto may be configured to consider relations between products when optimizing promotion sales plans, in accordance with aspects of the disclosure, as provided herein.

In the example of FIG. 1, the promotion scheduling management system 100 may include a promotion scheduling manager 120 configured to cause the at least one processor 100 to schedule one or more promotion events for each of one or more products relative to one or more time intervals while considering one or more constraints related to historic sales data for each of the one or more products.

In various implementations, the promotion scheduling manager 120 may consider the one or more constraints to meet and/or implement various logical business practices. For example, the one or more constraints may include restricted use of a specified number of potential promotion sales strategies determined for use with each of the one or more products within the one or more time intervals. In another example, the one or more constraints may include a specified number of instances that the potential promotion sales strategies are used for each of the one or more products within the one or more time intervals. In another example, the one or more constraints may include a specified revenue goal or a value greater than the specified revenue goal for scheduling the one or more promotion events within the one or more time intervals based on the one or more potential promotion sales strategies.

In various implementations, along with considering constraints related to historic sales data for the one or more products, the promotion scheduling manager 120 may consider other aspects of promotion scheduling including demand forecast and long-term effects. In an example, the promotion scheduling manager 120 may be configured to schedule the one or more promotion events for each of the one or more products based on forecasted customer demand relative to the one or more time intervals while considering the one or more constraints related to the historic sales data for each of the one or more products. In another example, the promotion scheduling manager 120 may be configured to schedule the one or more promotion events for each of the one or more products based on long-term effects to sales performance relative to the one or more time intervals while considering the one or more constraints related to the historic sales data for each of the one or more products. In another example, the promotion scheduling manager 120 may be configured to schedule the one or more promotion events for each of the one or more products relative to the one or more time intervals while considering forecasted customer demand related to the historic sales data for each of the one or more products. In another example, the promotion scheduling manager 120 may be configured to schedule the one or more promotion events for each of the one or more products relative to the one or more time intervals while considering long-term effects to sales performance related to the historic sales data for each of the one or more products.

The promotion scheduling manager 120 may include a promotion forecaster 122 configured to determine the one or more constraints based on the historic data for each of the one or more products. In various implementations, the historic data may include historic sales data for each of the one or more products.

The promotion scheduling manager 120 may include a promotion coordinator 124 configured to determine one or more potential promotion sales strategies for use with each of the one or more products within the one or more time intervals while considering the one or more constraints related to the historic sales data for each of the one or more products. In an implementation, the promotion coordinator 124 may be configured to determine the one or more potential promotion sales strategies for use with a combination of two or more products within the one or more time intervals while considering the one or more constraints related to the historic sales data for each of the one or more products.

The promotion scheduling manager 120 may include a promotion scheduling optimizer 128 configured to generate a promotion sales plan for scheduling the one or more promotion events within the one or more time intervals based on the one or more potential promotion sales strategies for use with each of the one or more products within the one or more time intervals while considering the one or more constraints related to the historic sales data for each of the one or more products. In some examples, the promotion sales plan may include multiple promotion sales plans, such as a plurality of varying or different promotion sales plans for scheduling the one or more promotion events within the one or more time intervals.

In an implementation, the promotion scheduling optimizer 128 may be configured to generate the promotion sales plan for scheduling the one or more promotion events within the one or more time intervals based on handling different forecast scenarios while considering the one or more constraints related to the historic sales data for each of the one or more products. In some examples, the different forecast scenarios may include one or more of adjusting to real-time scenarios and long-term scenarios related to one or more of different customer demand scenarios, different product inventory scenarios, and different sales performance scenarios.

In an implementation, the promotion scheduling manager 120 may include a promotion sales monitor 126 configured to monitor real-life or real-time sales data for each of the one or more products. In this instance, the promotion scheduling optimizer 128 may be configured to generate the promotion sales plan for scheduling the one or more promotion events within the one or more time intervals based on real-time sales data for each of the one or more products within the one or more time intervals while considering the one or more constraints related to the historic sales data for each of the one or more products.

In an implementation, the promotion scheduling management system 100 may include one or more databases 140 configured to store various information related to promotion scheduling management. For instance, the database(s) 140 may be configured to store information related to scheduling the one or more promotion events, information related to each of one or more products, information related to the one or more time intervals, information related to the one or more constraints, information related to the historic sales data for each of the one or more products, information related to the one or more potential promotion sales strategies for use with each of the one or more products, and information related to the one or more promotion sales plans for scheduling the one or more promotion events. Further, in reference to storing the historic sales data for each of the one or more products, the database(s) 140 may be configured to store information related to one or more of customer product demand, product sales history, current product inventory, and an amount of incoming products.

In the example of FIG. 1, it should be appreciated that the promotion scheduling management system 100 is illustrated using various functional blocks or modules that represent more-or-less discrete functionality. However, such illustration is provided for clarity and convenience, and thus, it should be appreciated that the various functionalities may overlap or be combined within a described block(s) or module(s), and/or may be implemented by one or more block(s) or module(s) not specifically illustrated in the example of FIG. 1. As such, it should be appreciated that conventional functionality that may be considered useful to the system 100 of FIG. 1 may be included as well even though such conventional elements are not illustrated explicitly, for the sake of clarity and convenience.

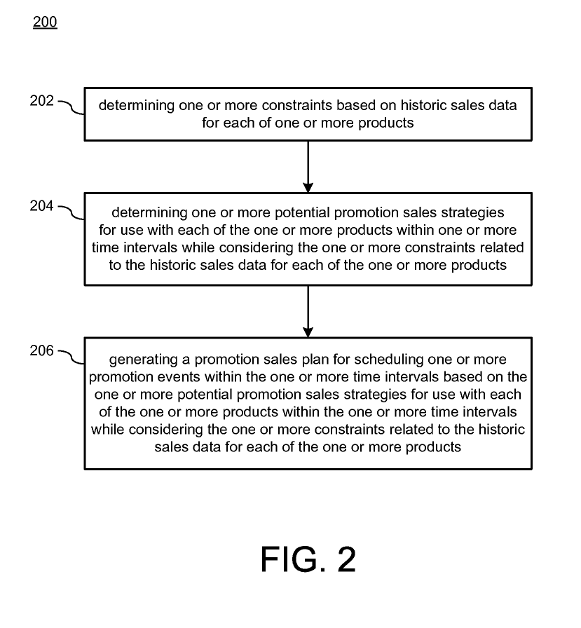

FIG. 2 is a process flow illustrating an example method 200 for managing promotion scheduling, in accordance with aspects of the disclosure.

In the example of FIG. 2, operations 202-206 are illustrated as discrete operations occurring in sequential order. However, it should be appreciated that, in other various implementations, two or more of the operations 202-206 may occur in a partially or completely overlapping or parallel manner, or in a nested or looped manner, or may occur in a different order than that shown. Further, additional operations, that may not be specifically shown in the example of FIG. 2, may be included in some implementations, while, in various other implementations, one or more of the operations 202-206 may be omitted. Further, in various implementations, the method 200 may include a process flow for a computer-implemented method for managing promotion scheduling in the system 100 of FIG. 1. Further, as described herein, the operations 202-206 may provide a simplified operational process flow that may be enacted by the computer system 104 to provide features and functionalities as described in reference to FIG. 1.

In various aspects of the disclosure, the method 200 of FIG. 2 may be provided for generating one or more promotion schedules and/or one or more promotion sales plans for one or more promotion events for each of one or more products relative to one or more time intervals. In various promotion sales environments, each of the one or more products may use one or more promotion schedules and/or one or more promotion sales plans for one or more promotion events relative to one or more time intervals.

In an implementation, the method 200 of FIG. 2 may be configured to schedule one or more promotion events for each of one or more products relative to one or more time intervals while considering one or more constraints related to historic sales data for each of the one or more products. For instance, in the example of FIG. 2, at 202, the method 200 may include determining one or more constraints based on historic sales data for each of one or more products.

In various implementations, the one or more constraints may include one or more of restricted use of a specified number of the potential promotion sales strategies determined for use with each of the one or more products within the one or more time intervals, a specified number of instances that the potential promotion sales strategies are used for each of the one or more products within the one or more time intervals, and a specified revenue goal or a value greater than the specified revenue goal for scheduling the one or more promotion events within the one or more time intervals based on the one or more potential promotion sales strategies.

At 204, the method 200 may include determining one or more potential promotion sales strategies for use with each of the one or more products within one or more time intervals while considering the one or more constraints related to the historic sales data for each of the one or more products. In some implementations, determining the one or more potential promotion sales strategies may be for use with a combination of two or more products within the one or more time intervals while considering the one or more constraints related to the historic sales data for each of the one or more products.

At 206, the method 200 may include generating a promotion sales plan for scheduling one or more promotion events within the one or more time intervals based on the one or more potential promotion sales strategies for use with each of the one or more products within the one or more time intervals while considering the one or more constraints related to the historic sales data for each of the one or more products. In an implementation, generating the promotion sales plan for scheduling the one or more promotion events within the one or more time intervals may be based on handling different forecast scenarios while considering the one or more constraints related to the historic sales data for each of the one or more products. In various examples, the different forecast scenarios including one or more of adjusting to real-time scenarios and long-term scenarios related to one or more of different customer demand scenarios, different product inventory scenarios, and different sales performance scenarios.

In an implementation, the method 200 of FIG. 2 may include monitoring real-time sales data for each of the one or more products. In this instance, generating the promotion sales plan for scheduling the one or more promotion events within the one or more time intervals may be based on the real-time sales data for each of the one or more products within the one or more time intervals while considering the one or more constraints related to the historic sales data for each of the one or more products.

In an implementation, the method 200 of FIG. 2 may include storing the historic sales data for each of the one or more products in one or more databases. In this instance, the historic sales data may include one or more of customer product demand, product sales history, current product inventory, and an amount of incoming products.

In accordance with aspects of the disclosure, the example system 100 of FIG. 1 for promotion scheduling management and the related method 200 in FIG. 2 may be configured for optimizing one or more promotion sales plans while considering, for example, demand forecast, long-term effects, and/or multiple constraints. The example system 100 and method 200 may be configured to store historic sales data and monitor real-time data flow including user demand, sales history, current inventory, and/or various amounts of incoming products. In some implementations, use of the example system 100 and method 200 allows for dynamic optimization of promotion sales plans, which may provide for real-time reaction to handle different scenarios while considering short-term effects and/or long-term effects. For instance, long-term effects may include situations where customers are used to seeing a product sold at a discounted price and may not buy the same product at a regular price. In another instance, long-term effects may include situations where a product is sold a lot during a promotion, but then is sold very little in the next few weeks following the promotion. Thus, the promotion may need to consider one or more constraints to meet logical business practices, such as, for example, only a small number of products may be discounted at time, and/or a small number of products may be combined together and promoted together, but not large numbers of products are combined and promoted together.

Further, data richness mentioned herein may be used to leverage data to support, estimate, and/or forecast various values that guide decision-making to generate promotion sales plans. For instance, expected customer demand may be forecasted when prices change due to sale promotions while considering total cost of sold goods. In an example, one technique may use a pre-defined equation to find a solution. However, in another example, historic sales data and other external factors may be utilized to build a unified forecast model, as described in reference to aspects of the disclosure.

In an implementation, after reasonable estimates about factors related to the promotion sales plan are taken into account, an objective function may be generated of which one or more input variables may be used as potential sales strategies with one or more pre-defined constraints. For instance, techniques including, e.g., linear optimization and/or quadratic computing, may be used to provide final results and/or solutions. Thus, the example system 100 of FIG. 1 for promotion scheduling management and the related method 200 in FIG. 2 may be configured to optimize one or more promotion sales plans while considering various aspects related thereto including, e.g., one or more of customer demand forecast, short-term effects, long-term effects, and one or more constraints.

In an implementation, the example system 100 and method 200 may be configured to estimate and/or forecast values of various factors considered essential for decision making based on historic sales data. In various examples, the external factors that may be considered by the example system 100 and method 200 may include one or more of trend, seasonality, anomaly events, etc.

In another implementation, the example system 100 and method 200 may be configured to provide a current promotion sales plan solution for considering one or more or several products at one time (e.g., a combination of products), which may or may not ignore relations between one or more or all selling products on an overall level. This may be considered essential for a promotion sales plan that needs a global optimum on one or more different objectives, such as revenue, profit, customer satisfaction, etc.

In another implementation, the example system 100 and method 200 may be configured to provide promotion sales plans that may vary depending on effects and other factors. For instance, promotion techniques may consider one or more of bundling, coupons, price discount, buying quantity for a lower unit price, buy x get y free, which provide possibilities for decision making choices. Considering these different techniques and combinations thereof may need a systematic approach for considering one or more or all possible solutions. In a promotion model, the example system 100 and method 200 may integrate one or more or all of these promotion techniques for optimization.

In another implementation, the example system 100 and method 200 may be configured to consider various constraints for real-time planning. For instance, for a product, two different sales promotions for one product at one time may be considered frustrating to customers, and too many discounts for the products in the same categories at the same time may likely reduce total revenue. As such, these various constraints may be considered essential to find a feasible plan and may be considered in the model.

In another implementation, the example system 100 and method 200 may be configured to consider sales promotion as a short-term behavior, and decision making may focus on short-term goals, such as revenue during sales promotions. However, sales after promotion may be considered from a long-term perspective, and demand elasticity of the customer may be considered as product price changes. For instance, with those products where demand elasticity is low, a large discount may harm sales performance in near future when price returns normal. As such, the example system 100 and method 200 may be configured to combine long-term effects with objective function.

In accordance with aspects of the disclosure, the example system 100 and method 200 may be configured to optimize promotion sales plans with model input and terminology while considering various constraints, as follows.

In an example, the model input may include price of the product. For instance, the product may be considered a finest unit that is sold. Price changes during a different promotion may be chosen.

pᵢ,iεN

In another example, the model input may include customer demand. For instance, customer demand may be defined as a function that is dependent on the product price. This may be a considered a simplified assumption in theory of microeconomics.

d(pᵢ)→R

While the above definition may be considered one method for modelling customer demand, there may be a point for the modelling that the input may be restricted to only a current product price regardless of other factors. As such, the customer demand may be modelled as a function with one or more parameters, such as, e.g., whether there is a promotion, how long is the promotion, and a status of other products. Therefore, in this instance, the function may be denoted as:

d(promotion info,length of promotion,other products info, . . . )→<dₜ_{₁},dₜ_{₂}, . . . ,dₜ_{ₙ}>

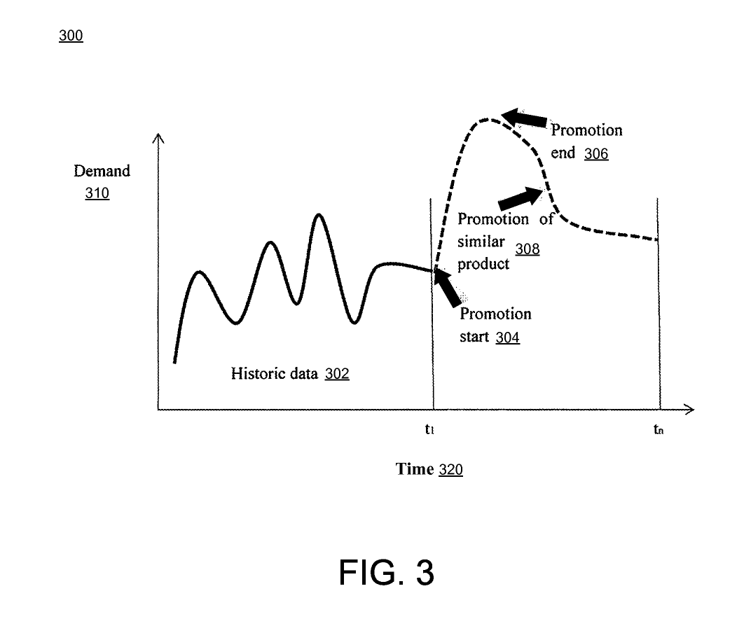

FIG. 3 is a diagram illustrating an example graph 300 showing customer demand, in accordance with aspects of the disclosure. In an implementation, an x-y coordinate system is used to track historic sales and forecasted sales of a product, and the example graph 300 includes demand 310 (x-axis) versus time 320 (y-axis). The example graph 300 plots historic data, such as historic sales data 302 prior to time t₁. At t₁, a sales promotion starts, and product sales are tracked and graphed to time tₙ. The example graph 300 plots a peak as defined at a sales promotion end 304, and sales are shown to decrease during promotion of a similar product 308. As shown in FIG. 3, the customer demand forecast during t₁ to tₙ, may not be a single value but a time series, since the long-term effect should be considered, especially when the promotion is ended.

In another example, the model input may include promotion strategy. As described in the above instance, there are many different promotion techniques. In the this instance, each possible promotion sales plan may be modelled as a vector of binary variables for one product, which may refer to price discount.

In an implementation, a constant discount value may be set for a product, for example, 10% off, 15% off . . . , and 50% off. One binary variable may be used to present product discount, if one particular discount level is used or not. For instance, if there are 10 possible discount levels, 10 binary variables may be needed to present the price discount strategy that is used. These variables may be combined into a vector:

$$\begin{matrix}{v}_{discount} = [ {v}_{discount - 1} , {v}_{discount - 2} , … ] \\ = [ is 10 \% off , is 15 \% off , … ] \\ = [ 0 , 1 , … ]\end{matrix}$$

In real-time, an assumption may be considered that, at one time, only ONE discount strategy may be used, e.g.,

Σv_{discount-i}≦1

In another instance, each possible promotion sales plan may be modelled as a vector of binary variables for one product, which may refer to coupon.

Following the discount modelling, a vector of binary variables may be used to present product coupon, if one certain type of coupon is used for the product.

v_{coupon}=[is type 1 used,is type 2 used, . . . ]=[0,1, . . . ]

Apart from the above two promotion techniques, other techniques, such as buying quantity for a lower unit price, and buying x to get y may be modeled as a vector of binary variables representing one product, if one method is used or not.

In another example, the model input may include promotion length and/or decaying weights. For instance, a promotion may include a valid time period, where 1 is defined as a length of one promotion in day units. On each day of the promotion, the lift of the promotion may be different. In this instance, take v_{discount} as an example; on day one of the promotion, the weight for each promotion plan may include:

L₁=[α₁₋₁,α₁₋₂, . . . ]

α₁₋₂ means weight on promotion day one if v_{discount-2} is used. This may be generalized as L₁, L₂, . . . to a matrix:

$$L = [ \begin{matrix}{α}_{1 - 1} & … & \\ ⋮ & ⋱ & ⋮ \\ {α}_{l - 1} & … & \end{matrix} ]$$

One point of the forecast may be to estimate L matrix to know how the different promotion plans may have impact on customer demand with time.

In one example, with model input, the example system 100 and method 200 may estimate customer demand with different possible promotion strategies and long-term effects. In another example, the example system 100 and method 200 may build an objective function and deploy optimization techniques to provide final results, answers, and/or solution, in accordance with aspects of the disclosure.

Referring to forecasting customer demand, one or more techniques may be used for predicting customer demand. In an example, a technique may include data pre-processing. For instance, historical data (e.g., historical sales data) may be stored in a database and pre-processed before forecast, which may include data retrieval, cleaning, normalization, transformation, feature extraction, selection, etc. In this instance, one or more promotion records may be transferred into binary vectors, as described herein.

In another example, a technique may include time series decomposing. For instance, as historic data for product demand are in time series format, decomposition may be needed to determine trend, seasonality, and/or a remainder of the time series.

User demand=trend+seasonality+remainder

This process may be performed with various techniques to determine the remainder part for use with other techniques, as follows.

In another example, a technique may include model promotion for one product. For instance, after decomposition, denote the remainder of the user demand for one product as Rᵥ and the time-window as d. v means a current date, and the historic data may be no later than d days before to perform the prediction. In this instance, price discount promotion may be used as an example when considering how promotion may partly interfere with Rᵥ. Define:

R_{v-discount}=Σᵢ₌₁^{d}[Rᵥ₋ᵢ₋ₗ₊₁,Rᵥ₋ᵢ₋ₗ₊₂, . . . ,Rᵥ₋ᵢ]×L·v_{discount}^{T}

This model may be referred to as a sub-model for Rᵥ. Other promotion sales plans may be modelled, as provided herein.

Further, since user demand of other products, whether it is substitution or complementary to the product now being considered, may affect the demand for the product, another sub-model for other products information may be added.

Rᵥ₋ₒₜₕₑᵣ=Σᵢ₌₁^{d}Σ_{jε{other products}} ω̅ᵥ₋ᵢ^{j}·Rᵥ₋ᵢ^{j}

Rᵥ₋ᵢ^{j} may be referred to as user demand for product j on day v-i, and ω̅ᵥ₋ᵢ^{j} is the corresponding weight.

In another example, a technique may include factors combining. For instance, when one or more sub-model is built, they may be combined together to provide an estimation of Rᵥ. In this instance, an estimation may be built based on price discount and other products information.

Rᵥ=f(R_{v-discount},Rᵥ₋ₒₜₕₑᵣ)

In some instances, additive or multiplicative combining may be considered enough for the estimation. However, if more knowledge on how different factors interact with each other is available, more complex combing may be achieved and/or used.

In another example, a technique may include regression. For instance, traditional linear/nonlinear regression techniques may be used, such as, e.g., ordinary least squares (OLS) regression, ridge regression, sparse regression, and/or support vector machine (SVM) regression with kernel. In some instances, the output may include one or more parameters, such as, e.g., L matrix and ω̅ᵥ₋ᵢ^{j}.

In another example, a technique may include predict customer demand time series. For instance, as described herein, a single value may be considered, and one or more sequence values may be considered in a next tₙ days. This is not difficult, since a technique to forecast user demand may be used one or more or several days later.

<Rᵥ,Rᵥ₊₁, . . . ,Rᵥ₊ₜ_{ₙ}>

Further, when the forecast remainders are determined, trend may be added (+) to seasonality to generate, e.g., a final real forecast.

<dₜ_{₁},dₜ_{₂}, . . . ,dₜ_{ₙ}>

Referring to objective function and optimization, one or more techniques may be used for building an objective function and deploying optimization techniques to provide final results, answers, and/or solution. After a first stage, an estimate may be generated for each and/or every product with possible promotion sales plans with use of one or more of the following techniques and/or procedures.

In an example, a technique may include set objective. For instance, with reference to one or more goals, a retailer may need to provide or set an objective. In this instance, the set objective may include maximizing revenue.

In another example, a technique may include one product. For instance, with reference to product, there may be k possible promotion techniques, where:

vⱼ={0,1},j≦k

this may refer to whether the promotion techniques is chosen or not. The revenue of the product may include:

Revenueᵢ=Σⱼ₌₁^{k}vⱼ·Σₜ₌ₜ_{₁}^{t}^{ₙ}p(j,t)·dₜ^{j},vⱼ={0,1},j≦k

p(j, t) may refer to a price at time t, and dₜ^{j} may refer to user demand at time t, if j promotion method is used.

In another example, a technique may include multiple products (e.g., a combination of products). For instance, when products in a baskets are to be considered to generate a global optimum, the objective function may be provided as:

maximize Σᵢ₌₁^{N}Revenueᵢ

In another example, a technique may include constraints. For instance, in real-life or real-time, one or more constraints may exist for the maximization problem. In this instance, for one product, at most d promotion techniques may be used at one time:

∀productᵢ,j,Σⱼ₌₁^{k}vᵢⱼ≦d

For certain products, the revenue may be more than a pre-defined value:

for productᵢ,Revenueᵢ≧valᵢ

The overall promotions may not be more than u times:

∀productᵢ,j,Σᵢ₌₁^{N}Σⱼ₌₁^{k}vᵢⱼ≦u

In accordance with aspects of the disclosure, as described in reference to the above examples and instances, the example system 100 and method 200 provides a flexible framework to add one or more various constraints whenever decision-making thinks it's necessary. Further, in reference to optimization, linear/non-linear optimization solvers may be used to return a result. In various examples, Heuristic-based algorithms may be used in certain scenarios to boost speed and determine approximate solutions.

In reference to the model, experiments on some simulated datasets may be conducted. The experiments may be performed to focus on optimization time in regard to different parameters. For simulated data, various performance tests may need datasets on different scales. In some examples, traditional simulation of data may be performed. In some examples, historical data may be generated by sampling real sales data, factors table, and using some distribution mixture. In some examples, regression techniques may be used to estimate customer demand for each product:

<dₜ_{₁},dₜ_{₂}, . . . ,dₜ_{ₙ}>

In some examples, demand forecast may be considered an offline process and optimization may be considered an online process, related experiments may focus on performance of the optimization.

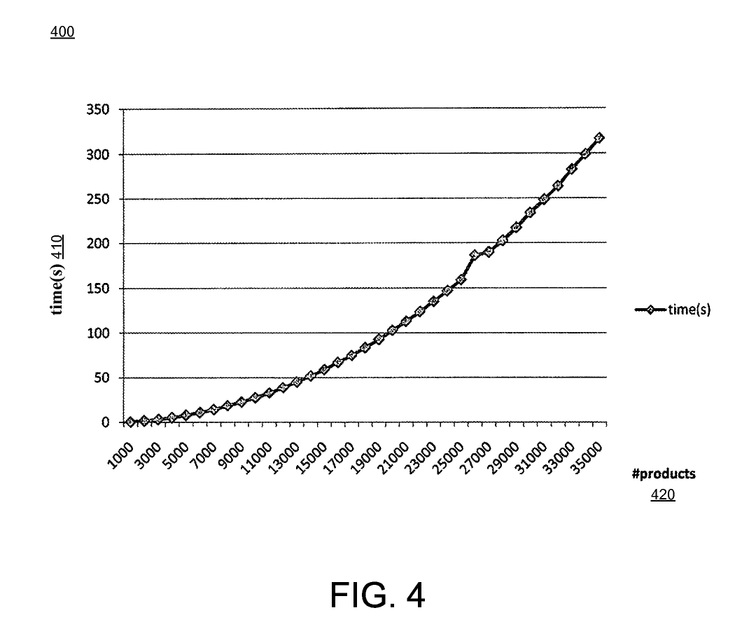

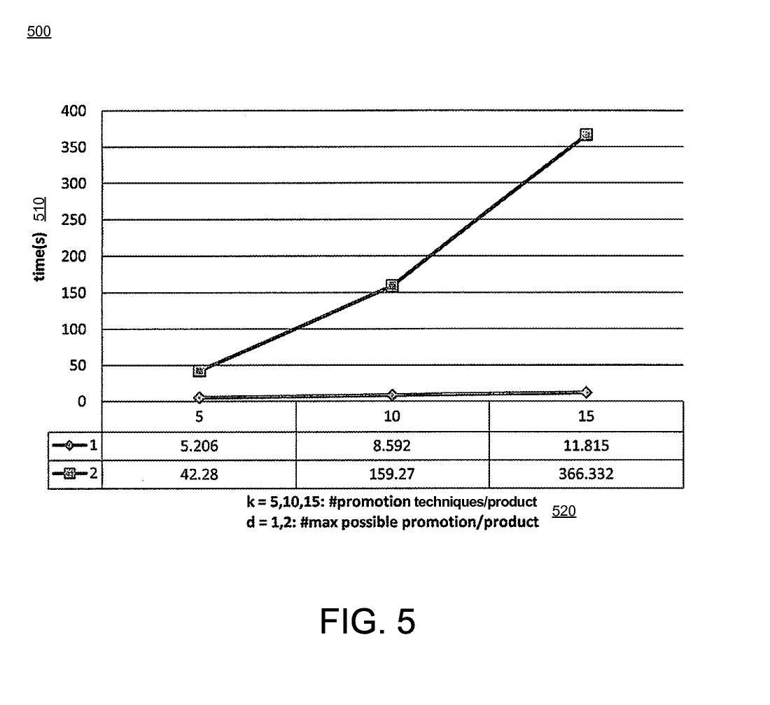

For parameter setting, one or more parameters may be used for flexibility in the optimization including, e.g., one or more of number of total products: p, number of possible promotion methods for each product: k, maximum number of applied promotion methods for each product: d, and maximum number of total promotion methods used in one optimization: u. FIGS. 4 and 5 show example use of the one or more parameters and how the one or more parameters may influence optimization and performance.

FIG. 4 is a diagram illustrating an example graph 400 showing time for achieving optimal solutions with different numbers of products in an optimization, in accordance with aspects of the disclosure. In an implementation, an x-y coordinate system is used to track time 410 and numbers of products 420, and the example graph 400 includes time 410 (x-axis) versus number of products 420 (y-axis). The example graph 400 shows the time parameter needed to achieve an optimal solution with different number of products parameter in the optimization. In this example, the other parameters may be set as: k=10, d=2 and u=10%*p. With the example graph 400, the increase of the total products may be determined when the time increases exponentially. In a specific example, for a scale of 35,000 products, 5 minutes may be acceptable.

FIG. 5 is a diagram illustrating an example graph 500 showing how the parameters k and d may affect performance, in accordance with aspects of the disclosure. In an implementation, an x-y coordinate system is used to track time 510 and numbers of products 520, and the example graph 500 includes time 510 (x-axis) versus number of products 520 (y-axis). In the example graph 500, p may be set to 25,000 and u may be set to 2,500. As shown, d may be considered a critical factor and may cause dramatic performance problems when d is larger than 2. However, in a real case, for each product, it may not be reasonable to allow many promotion techniques at a time. If d is set less or equal to 2, the performance may be considered acceptable in a real business scenario.

In accordance with aspects of the disclosure, the example system 100 and related method 200 may be configured for forecasting customer demand. For instance, for each product, sales history may be analyzed in reference to historic promotion sales information. The sales curve may be modeled and a forecast model may be generated.

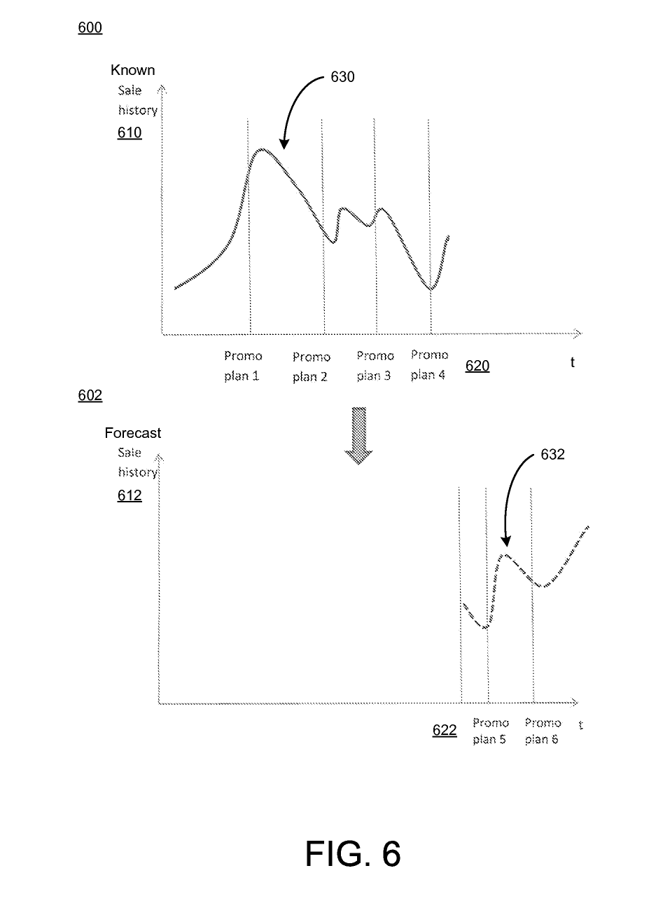

FIG. 6 is a diagram illustrating example graphs 600 and 602 showing how to model a forecast sales curve 632 from a known sales curve 630, in accordance with aspects of the disclosure. In an implementation, the example graph 600 shows an x-y coordinate system that is used to track known sales history 610 of a product and one or more promotion sales plans 620 related to the product over time t, and the example graph 600 includes known sales history 610 (x-axis) versus promotion sales plans 620 (y-axis) over time t to generate the known sales curve 630. Further, in another implementation, the forecast sales curve 602 shows an x-y coordinate system that is used to track forecast sales history 612 (predictions) of the product and one or more promotion sales plans 622 related to the product over time t, and the example graph 602 includes forecast sales history 612 (x-axis) (predictions) versus promotion sales plans 622 (y-axis) over time t to generate or predict the forecast sales curve 632.

In an example, a technique for modeling the sales curve may include data pre-processing, time series decomposition, modeling the sales curve considering one or more factors including promotion plan and sales of other products, regression method, and determining a demand curve. The sales curve may be referred to as a function F, and the parameters of the function F may include time, which promotion sales plan will be used, and sales information of other products. For each single product, a promotion sales plan may be executed to determine what demand will be like.

Further, for objective function and optimization, promotion of one or more or all products may be considered. For instance, if the promotion sales plan is designed product by product, the maximum revenue (or other objectives) may or may not be achieved in total. Hence, all the promotion may be planned at one time. In this instance, linear/nonlinear optimization may be used. During optimizing, there may be one or more or several constraints to consider, such as maximum promotion plan at one time and/or target revenue for a single/group of products.

For example, referring to Table 1, suppose there are only two products A and B, after analysis of sales history, the demand curve for A may appear as:

TABLE 1

| Sale(A) forecast | T1 | T2 | T3 |
|---|---|---|---|
| Coupon + sales(B) > 100 | 150 | 170 | 140 |
| Buy 2 one free + sales(B) < 50 | 230 | 270 | 180 |
| . . . | . . . | . . . | . . . |

Please note demand may be a function with close form expression. The example is considered for simplicity.

In an example, for each product and each time, the demand may depend on the promotion sales plan and other products. In another example, for each product and each time, there may be several promotion sales plans, where only one may be used.

Further, in another example, when each product has its demand curve, a determination may be made as to which promotion sales plans is selected. For instance, as shown in Table 1 for A, there may be different promotion sales plans, and only one may be chosen at a time. This may be solved by optimization.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for user interaction, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other types of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of networks, such as communication networks, may include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions recorded on a non-transitory computer-readable medium and executable by at least one processor, the system comprising:
a promotion scheduling manager configured to cause the at least one processor to schedule one or more promotion events for each of one or more products relative to one or more time intervals while considering one or more constraints related to historic sales data for each of the one or more products, wherein the promotion scheduling manager includes:
a promotion forecaster configured to determine the one or more constraints based on the historic sales data for each of the one or more products;
a promotion coordinator configured to determine one or more potential promotion sales strategies for use with each of the one or more products within the one or more time intervals while considering the one or more constraints related to the historic sales data for each of the one or more products; and
a promotion scheduling optimizer configured to generate a promotion sales plan for scheduling the one or more promotion events within the one or more time intervals based on the one or more potential promotion sales strategies for use with each of the one or more products within the one or more time intervals while considering the one or more constraints related to the historic sales data for each of the one or more products.

2. The computer system of claim 1, wherein the promotion scheduling manager is configured to schedule the one or more promotion events for each of the one or more products based on forecasted customer demand relative to the one or more time intervals while considering the one or more constraints related to the historic sales data for each of the one or more products.

3. The computer system of claim 1, wherein the promotion scheduling manager is configured to schedule the one or more promotion events for each of the one or more products based on long-term effects to sales performance relative to the one or more time intervals while considering the one or more constraints related to the historic sales data for each of the one or more products.

4. The computer system of claim 1, wherein the promotion scheduling manager is configured to schedule the one or more promotion events for each of the one or more products relative to the one or more time intervals while considering forecasted customer demand related to the historic sales data for each of the one or more products.

5. The computer system of claim 1, wherein the promotion scheduling manager is configured to schedule the one or more promotion events for each of the one or more products relative to the one or more time intervals while considering long-term effects to sales performance related to the historic sales data for each of the one or more products.

6. The computer system of claim 1, wherein the promotion coordinator is configured to determine the one or more potential promotion sales strategies for use with a combination of two or more products within the one or more time intervals while considering the one or more constraints related to the historic sales data for each of the one or more products.

7. The computer system of claim 1, wherein the promotion scheduling optimizer is configured to generate the promotion sales plan for scheduling the one or more promotion events within the one or more time intervals based on handling different forecast scenarios while considering the one or more constraints related to the historic sales data for each of the one or more products, the different forecast scenarios including one or more of adjusting to real-time scenarios and long-term scenarios related to one or more of different customer demand scenarios, different product inventory scenarios, and different sales performance scenarios.

8. The computer system of claim 1, wherein the one or more constraints include restricted use of a specified number of the potential promotion sales strategies determined for use with each of the one or more products within the one or more time intervals.

9. The computer system of claim 1, wherein the one or more constraints include a specified number of instances that the potential promotion sales strategies are used for each of the one or more products within the one or more time intervals.

10. The computer system of claim 1, wherein the one or more constraints include a specified revenue goal or a value greater than the specified revenue goal for scheduling the one or more promotion events within the one or more time intervals based on the one or more potential promotion sales strategies.

11. The computer system of claim 1, further comprising a promotion sales monitor configured to monitor real-time sales data for each of the one or more products.

12. The computer system of claim 1, wherein the promotion scheduling optimizer is configured to generate the promotion sales plan for scheduling the one or more promotion events within the one or more time intervals based on real-time sales data for each of the one or more products within the one or more time intervals while considering the one or more constraints related to the historic sales data for each of the one or more products.

13. The computer system of claim 1, further comprising one or more databases configured to store the historic sales data for each of the one or more products.

14. The computer system of claim 1, wherein the historic sales data includes one or more of customer product demand, product sales history, current product inventory, and an amount of incoming products.

15. A computer program product, the computer program product being tangibly embodied on a non-transitory computer-readable storage medium and including instructions that, when executed by at least one processor, are configured to:
determine one or more constraints based on historic sales data for each of one or more products;
determine one or more potential promotion sales strategies for use with each of the one or more products within one or more time intervals while considering the one or more constraints related to the historic sales data for each of the one or more products; and
generate a promotion sales plan for scheduling one or more promotion events within the one or more time intervals based on the one or more potential promotion sales strategies for use with each of the one or more products within the one or more time intervals while considering the one or more constraints related to the historic sales data for each of the one or more products.

16. The computer program product of claim 15, wherein the instructions that, when executed by the at least one processor, are configured to generate the promotion sales plan for scheduling the one or more promotion events within the one or more time intervals is based on handling different forecast scenarios while considering the one or more constraints related to the historic sales data for each of the one or more products, the different forecast scenarios including one or more of adjusting to real-time scenarios and long-term scenarios related to one or more of different customer demand scenarios, different product inventory scenarios, and different sales performance scenarios.

17. The computer program product of claim 15, wherein the one or more constraints include one or more of:
restricted use of a specified number of the potential promotion sales strategies determined for use with each of the one or more products within the one or more time intervals,
a specified number of instances that the potential promotion sales strategies are used for each of the one or more products within the one or more time intervals, and
a specified revenue goal or a value greater than the specified revenue goal for scheduling the one or more promotion events within the one or more time intervals based on the one or more potential promotion sales strategies.

18. The computer program product of claim 15, further comprising:
instructions that, when executed by the at least one processor, are configured to monitor real-time sales data for each of the one or more products, and
the instructions that, when executed by the at least one processor, are configured to generate the promotion sales plan for scheduling the one or more promotion events within the one or more time intervals is based on the real-time sales data for each of the one or more products within the one or more time intervals while considering the one or more constraints related to the historic sales data for each of the one or more products.

19. The computer program product of claim 15, further comprising:
instructions that, when executed by the at least one processor, are configured to store the historic sales data for each of the one or more products in one or more databases, the historic sales data including one or more of customer product demand, product sales history, current product inventory, and an amount of incoming products.

20. A computer-implemented method, comprising:
determining one or more constraints based on historic sales data for each of one or more products;
determining one or more potential promotion sales strategies for use with each of the one or more products within one or more time intervals while considering the one or more constraints related to the historic sales data for each of the one or more products; and
generating a promotion sales plan for scheduling one or more promotion events within the one or more time intervals based on the one or more potential promotion sales strategies for use with each of the one or more products within the one or more time intervals while considering the one or more constraints related to the historic sales data for each of the one or more products.
